(19) United States
(12) Patent Application Publication
(10) Pub. No.: US 2002/0105668 A1
(43) Pub. Date: Aug. 8, 2002

(54) Print consumables monitoring

(76) Inventors: Kevin R. Lilland, Prior Lake, MN (US); Steven S. Hoge, Minnetonka, MN (US)

Correspondence Address: Brian D. Kaul, WESTMAN CHAMPLIN & KELLY, International Centre - Suite 1600, 900 South Second Avenue, Minneapolis, MN, 55402-3319, US

(21) Appl. No.: 10/012,016

(22) Filed: Nov. 9, 2001

Related U.S. Application Data
(60) Provisional application No. 60/116,469, filed on Jan. 20, 1999.

(51) Int. Cl. G06K 15/02; G06F 3/12; B41J 29/393

(52) U.S. Cl. 358/1.14; 399/24; 347/19

(57) ABSTRACT

A method for monitoring print consumables of a compact disc (CD) printing system estimates a number of images that can be printed before a print consumable of the CD printing system becomes depleted or reaches a low threshold level. The estimation is based upon a remaining print consumable amount that is available to the CD printing system and a requested print consumable amount. Print consumable information including the number of images that can be printed is then displayed.

### CROSS REFERENCE TO RELATED APPLICATIONS

The present invention claims the benefit of U.S. patent application ser. No. 09/488,091, entitled “A SYSTEM AND METHOD FOR MONITORING PRINT CONSUMABLES OF A PRINT DEVICE,” filed Jan. 18, 2000, which in turn claims the benefit of U.S. Provisional Application Number 60/116,469, entitled “PRINT CONSUMABLES MONITORING AND PLANNING DEVICE,” and filed Jan. 20, 1999, both of which are incorporated herein by reference.

### BACKGROUND

The present invention relates to a system and method for monitoring print consumables. More particularly, the present invention relates to a system and method for monitoring print consumables of a compact disc (CD) printing system and displaying print consumable information.

A typical CD printing system includes a general purpose computer connected to a peripheral compact disc (CD) printing device. A software application running on the computer provides a print job, consisting of an image file and a copy number, to the CD printing device. The image file contains data on an image that is to be rendered by the CD printing device and the copy number indicates how many copies of the image file are to be rendered or the number of CD's the CD printing device is to record the image on. The CD printing device utilizes at least one print consumable to render the image onto a surface of a CD in accordance with the print job. Typical print consumables include, ink (e.g., inkjet based printing), toner (laser based printing), colored dye ribbons (dye sublimation based printing), and wax based ribbons (waxed thermal transfer based printing).

The process of rendering a print job of a CD printing system, once started, is generally automated by the CD printing device. After the image file is rendered onto one CD, another CD is loaded into the printing device for printing, and repeated until all of the copies of the print job are rendered.

In the current state of the art of computerized CD printing systems, use and remaining levels of print consumables are determined as each print job is rendered. The quantity of print consumables remaining in the printing device is calculated after printing an image by subtracting the amount of print consumable used by the printing device to render the image from a known quantity of print consumable that was available to the printing device immediately prior to the rendering of the image. This method is illustrated in FIG. 1. At step 10, the software application instructs the printing device to print X copies of an image file. At step 12, a single copy of the image file is rendered by the printing device onto a print media, such as a compact disc. At step 14, the amount of print consumable that is available to the printing device is updated by subtracting the amount of print consumable used to render the image file from the amount of print consumable that was available to the printing device just prior to the rendering of the image file. If there are still copies to be rendered at step 16, the method returns to step 12 to render another copy of the image file. If, at step 16, all the copies of the image file have been rendered, then the print job has been completely rendered as indicated by step 18.

The current method for rendering print jobs is acceptable for small print jobs, while the printing device is attended. However, typical print jobs are quite large (large copy number). Additionally, it is common for the CD printing device to be left unattended during the rendering of such large print jobs. During such times, it is possible that the print consumable that is available to the CD printing device can become unexpectedly exhausted unbeknownst to the operator until he or she returns to check on the CD printing device. This can result in higher production costs due to a reduction in efficiency caused by the loss of the CD's on which the image could not be properly rendered due to the lack of print consumable or the automatic shutdown of the print job due to an exhausted print consumable. In an attempt to avoid this problem, it is common for print consumables to be replaced prematurely to ensure that an adequate amount of print consumable is available to the CD printing device to completely render a print job. This premature discarding of the print consumable further increases production costs.

It would, therefore, be advantageous to calculate the amount of print consumables a given print job will require prior to commencing the rendering of the print job. If the calculation reveals that an insufficient quantity of print consumable is available to the printing device to complete the rendering of the print, the rendering of the print job can be interrupted before the operator of the CD printing device leaves the CD printing device unattended.

### SUMMARY

The present invention relates to a method for monitoring print consumables of a compact disc (CD) printing system. The method generally estimates a number of images that can be printed before the print consumable becomes depleted or reaches a low threshold level based upon a remaining print consumable amount that is available to the CD printing system and a requested print consumable amount. Next, print consumable information including the number of images that can be printed is displayed. Also presented is a CD printing system that is adapted to perform the above-described method.

### BRIEF DESCRIPTION OF THE DRAWINGS

FIG. 1 shows a flowchart illustrating a method used by the prior art to monitor print consumable usage of a computerized printing device.

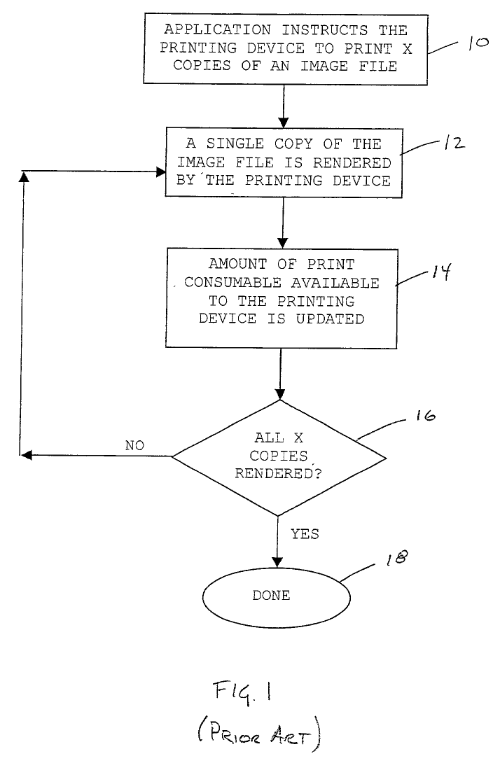

FIG. 2 shows a simplified block diagram of a compact disc printing system in accordance with various embodiments of the invention.

FIG. 3 shows a perspective drawing of a compact disc printing device with parts broken away.

FIG. 4 is a flowchart illustrating a method used to monitor print consumable usage of a compact disc printing system in accordance with one embodiment of the invention.

FIG. 5 is an example of a display of print consumable information in accordance with various embodiments of the invention.

FIG. 6 is a flowchart illustrating a method used to render a print job in accordance with one embodiment of the invention.

FIG. 7 is a flowchart illustrating a method of interrupting or rendering a print job in accordance with one embodiment of the invention.

FIG. 8 is a flowchart illustrating a method used to monitor print consumable usage of a compact disc printing system in accordance with one embodiment of the invention.

FIG. 9 is a flowchart illustrating optional actions that can be performed in the event the rendering of a print job is interrupted.

### DETAILED DESCRIPTION

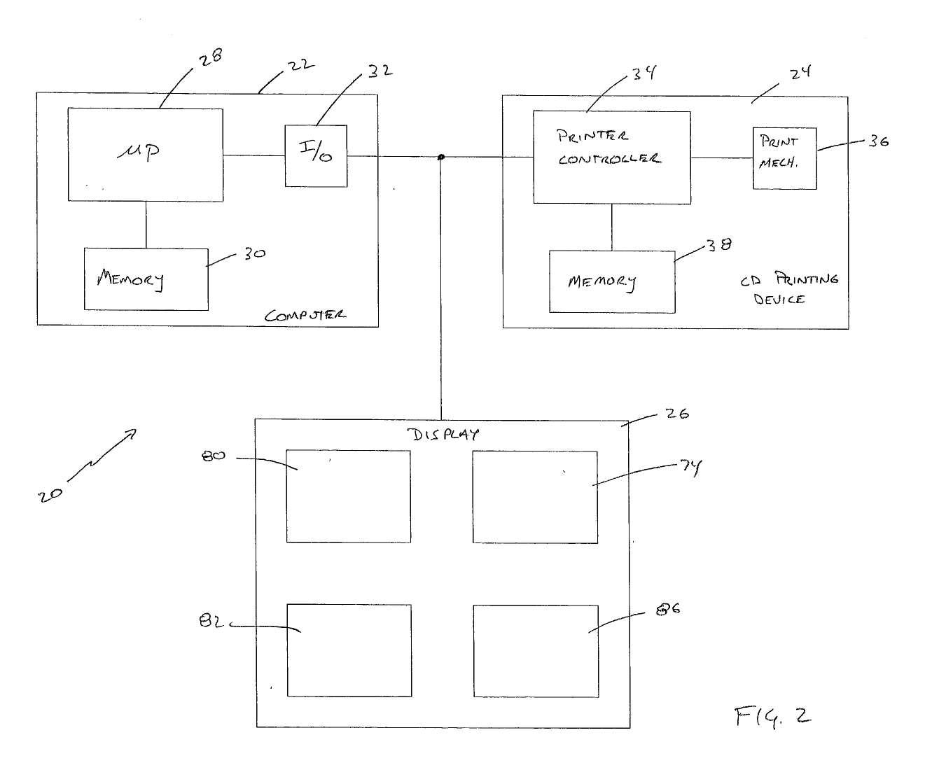

FIG. 2 is a simplified block diagram of an example of a compact disc (CD) printing system 20, in accordance with the present invention. The system 20 includes a computer 22, a CD printing device 24, and a display 26. In general, CD printing system 20 is adapted to print images onto CD's using a print consumable in accordance with a print job. It should be understood that the present invention is equally applicable to monitoring print consumables used to render print jobs onto digital video discs, recordable CD's, CD-ROM's, and other CD-like media. To simplify the discussion of the invention, references to a CD are intended to include all forms of CD-like media. Additionally, CD printing system 20 displays print consumable information to an operator of system 20 on a conventional display 26 that at least includes a number of images that can be printed based upon the remaining amount of print consumable that is available to CD printing device 24. In this manner, the operator of CD printing system 20 can determine, in advance of the rendering of the print job, whether the print job can be completed prior to the exhaustion of the print consumable.

Computer 22 generally includes a microprocessor 28, a memory 30, and an input/output (I/O) port 32. A software application store, for example, in memory 30, can be executed by microprocessor 28 and is configured to produce a print job. The print job is communicated to CD printing device 24 in a recognizable format through I/O port 32. One embodiment of the print job includes at least one image file and a copy number. The image file generally contains data of an image, text, or both, that is to be printed onto a CD by CD printing device 24. The copy number indicates number of times the image is to be rendered or the number of CD's the image is to be rendered on. In accordance with another embodiment of the invention, the print job includes a print quality setting that modifies the quality of the rendered image by adjusting the amount of print consumable used to print it.

CD printing device 24 includes a printer controller or processor 34 that is electronically coupled to computer 22 through I/O port 32. A print mechanism 36 of CD printing device 24 utilizes at least one print consumable to render an image file onto a CD. Examples of typical print consumables for use with CD printing device 24 include, color and/or black ink (e.g., inkjet based printing), toner (laser based printing), colored dye ribbons (dye sublimation based printing), and waxed based ribbons (wax thermal transfer base printing). A memory 38, accessible by printer controller 34, can be contained within CD printing device 24 for storage of programs and data including print consumable information.

CD printing devices 24 can be adapted to automatically load and unload CD's in order to process a large number of CDs without the aid of an operator in accordance with known methods. As a result, CD printing device 24 can be left unattended during the rendering of a large print job having a large copy number. An example of a suitable CD printing device 24 is the Signature II™ CD color printer manufactured by Primera Technology, Inc. of Plymouth, Minn., and described in U.S. Pat. No. 5,927,208, which is incorporated herein by reference.

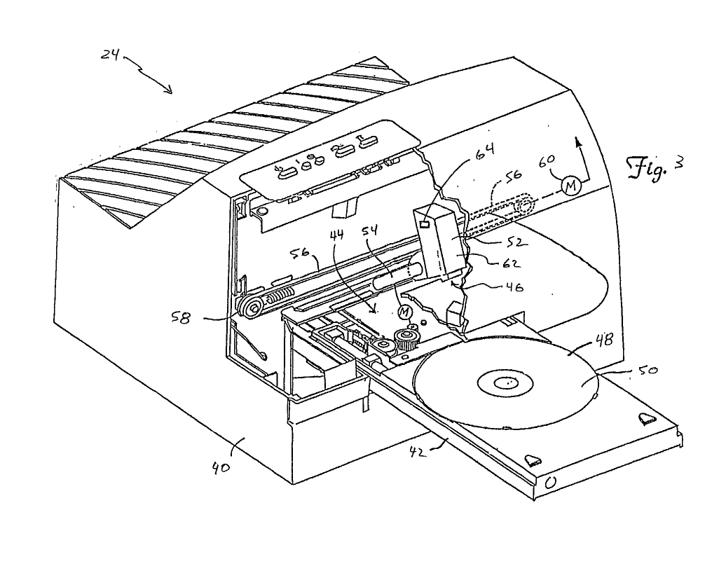

One example of CD printing device 24 is shown in FIG. 3. CD printing device 24 generally includes a housing 40, a tray 42, CD loading and positioning components 44, and a print mechanism or head 46. Tray 42 is configured to hold a CD 48 having a surface 50 upon which an image is to be recorded. Tray 42 is shown in its extended position where a CD 46 can be placed onto tray 42 and loaded into CD printing device 24. Tray 42 also has a printing position where tray 42 is retracted into housing 40 such that a CD 48 on tray 42 is presented to print mechanism 46 for printing on surface 50 using print consumable 52. Tray 42 is moved between the extended position and the printing position using CD loading and positioning components 44. Print mechanism 46 is mounted on a lateral slide rod 54. Movement of print mechanism 46 is controlled by belt 56 that is mounted on pulleys 58 and is driven by a stepper motor 60.

Print mechanism 46 and print consumable 52 are respectively shown as a conventional inkjet print head and an inkjet cartridge 62 containing an ink print consumable. In one embodiment of the invention, the supply of print consumable 52, such as cartridge 62, includes a memory circuit 64, in which print consumable information is stored that relates to the print consumable contained therein. Memory circuit 56 can be formed in accordance with known designs that include, for example, wireless or radio frequency communication with printer controller 34 of CD printing device 24.

CD printing system 20 is adapted to maintain print consumable information including a remaining print consumable amount and a requested print consumable amount. The remaining print consumable amount is the amount of print consumable 52 that is currently available to or loaded in CD printing device 24. This print consumable information can be stored in memory 30 of computer 22, memory 38 of CD printing device 24, or memory circuit 64 of the print consumable supply. The remaining print consumable amount, which can be accessed by microprocessor 28 or printer controller 34, can be periodically updated as print consumable is used by CD printing device 24.

The requested print consumable amount is generally used to calculate a number of images that CD printing device 24 can render prior to the depletion of print consumable 52. In accordance with various embodiments of the invention, the requested print consumable amount can be: a predetermined value stored in memory (such as memory 30, 38 or 64) that is set in accordance with a default image file; an amount of print consumable that is required to print a single image or all images of the current print job; or an average or maximum amount of print consumable that has been used to render past images in accordance with data contained in a print history that is stored in memory and maintained by the processors of CD printing system 20. The amount of print consumable that is required to render a given image depends on the number of pixels to be rendered, their intensity, and a quality setting. This information is provided in the image file of the print job. The requested print consumable amount that is required to process an entire print job is simply the product of the requested print consumable amount needed to render a single copy of the image multiplied by the copy number.

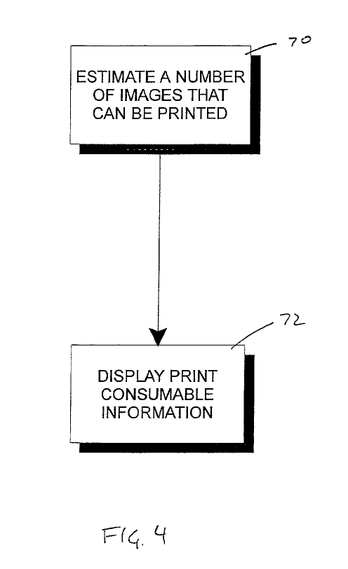

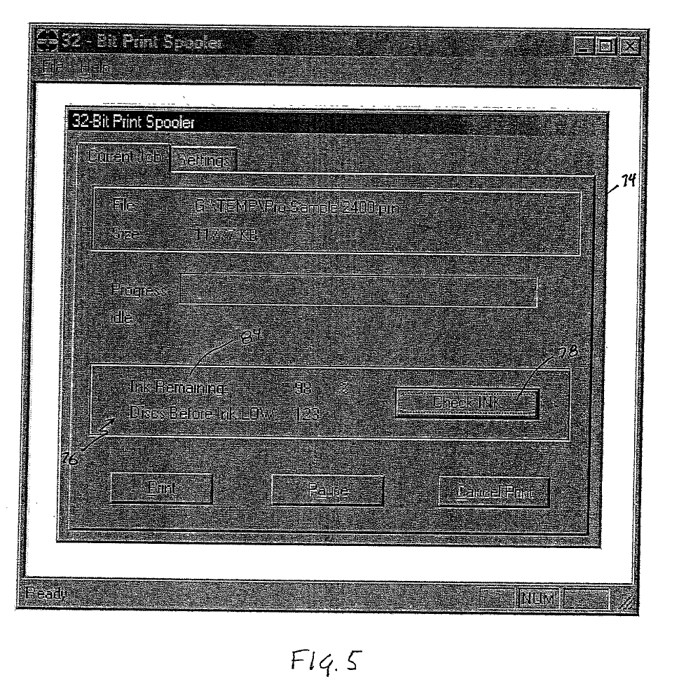

One embodiment of the invention relates to a method for monitoring at least one print consumable of CD printing system 20 in accordance with the flowchart of FIG. 4. At step 70, a number of images that can be printed before the print consumable becomes depleted or reaches a low threshold is estimated by dividing the remaining print consumable amount by the requested print consumable amount that is required to render a single image. The low threshold is preferably set high enough to ensure that the calculation is correct and low enough to ensure that nearly all of the print consumable is depleted. As mentioned above, the requested print consumable amount can be set in accordance with a default image, a predetermined value, or a print history containing data on previously rendered print jobs. At step 72 of the method, print consumable information is displayed on display 26 including the number of images that can be printed as indicated by box 74 of FIG. 2. An example of such a display is shown in FIG. 5 with the number of images that can be printed being one hundred and eighty-one, which is labeled in terms of the number of discs before the ink reaches a low threshold at 76. Alternatively, a graphical representation, such as a bar graph, can be used to represent the number of images that can be printed before the print consumable is low or depleted. This method, implemented in software stored in memory of the CD printing system 20, can be activated by an operator by, for example, clicking a button 78, shown in FIG. 5.

Other types of print consumable information can also be displayed on display 26 in accordance with various embodiments of the invention. For instance, a number of black and white images or color images that can be printed can be displayed, shown in FIG. 2 as box 80. These figures can be determined using a remaining print consumable amount corresponding to black and color print consumables 52, respectively. Additionally, the remaining amount of print consumable, represented by box 82 of FIG. 2, can be shown. The remaining print consumable amount can be displayed in terms of a percentage, as indicated at 84 of FIG. 5, or by another suitable representation. Furthermore, the remaining color and/or black print consumable amounts can be represented separately. Finally, statistical information, represented by box 86, can also be provided. This statistical information includes, for example, an average number of prints rendered per print consumable, a maximum number of prints rendered per print consumable, and a minimum number of prints rendered per print consumable.

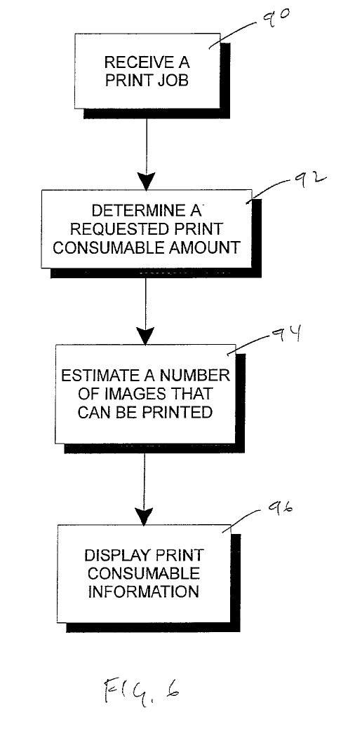

FIG. 6 is a flowchart illustrating another method of monitoring at least one print consumable of a CD printing system 20 in accordance with an embodiment of the invention. After receiving a print job at step 90, a requested print consumable amount for the print job is determined based upon the image file and copy number of the print job is determined at step 92. As explained above, the requested print consumable amount for the print job is determined by calculating the product of the amount of print consumable required to render the image once and the copy number. At step 94, the number of images that can be printed using the print consumable 52 is estimated by dividing the remaining print consumable amount by the requested print consumable amount to render a single image. Here, the requested print consumable amount can correspond to an amount of print consumable that is required to render the image of the print job once, the amount of print consumable required to render a default image, a predetermined value, or an average or maximum amount of print consumable that has been used in past print jobs as recorded a print history. The default image, predetermined value, and print history can be stored in memory 30, 38 or 64 (FIG. 3) of CD printing system 20. Finally, at step 96, print consumable information including the number of images that can be printed is displayed on display 26 (FIG. 2).

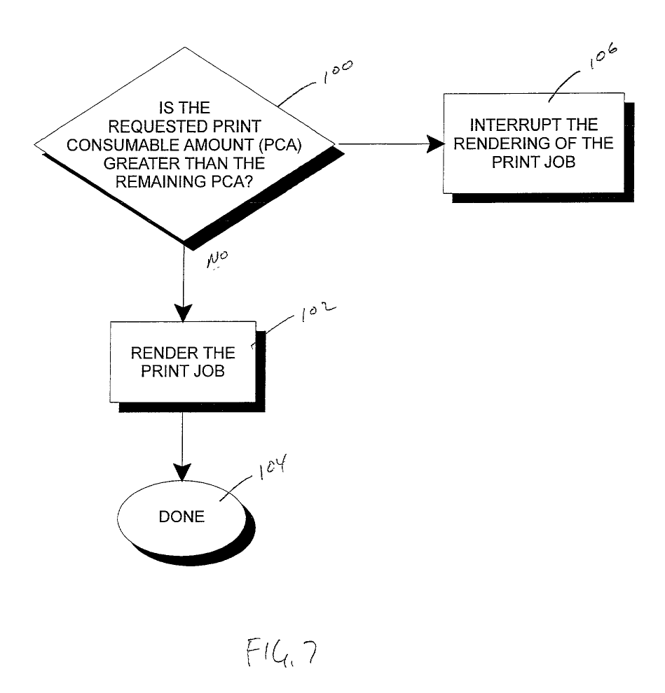

In accordance with another embodiment of the invention, a comparison is made between the copy number and the number of images that can be printed, prior to rendering the print job following step 96 of FIG. 6, as indicated at step 100 of the flowchart of FIG. 7. Alternatively, the requested print consumable amount needed to render the entire print job can be compared with the remaining print consumable amount. If the copy number does not exceed the number of images that can be printed, the print job is processed by printer controller 34 of CD printing device 24, at step 102. After all of the copies of the image file of the print job have been printed, the processing of the print job is completed as indicated at step 104. On the other hand, if the copy number exceeds the number of images that can be printed, then the processing of the print job is interrupted at step 106.

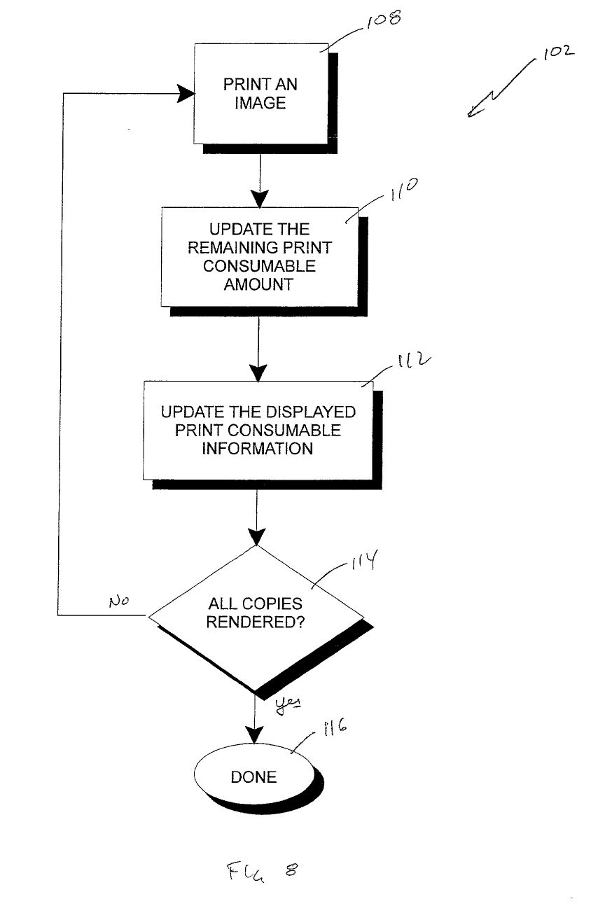

FIG. 8 shows one embodiment of the rendering step 102. At step 108, a single copy of the image represented by the image file is printed. At step 110, the remaining print consumable amount is updated by deducting the amount of print consumable used to print the image in step 108. At step 112, the displayed print consumable information, such as the number of images that can be printed and the remaining print consumable amount, is updated. At step, 114 a check is made to determine whether the print job has been completely rendered by comparing the copy number to the number of images that have been printed at step 108. If the print job has not been completely rendered, then the method returns to step 100. If the print job has been completely rendered, the method ends as indicated at step 116.

The interrupting step 106 is intended to prevent the undesirable occurrence of having the CD printing system 20 attempt to render a print job that requires more print consumable 52 than is available to CD printing device 24. In one embodiment, a warning is provided informing the user or operator that the print job cannot be completely rendered. The warning may consist of an alarm and a text message that indicates that the remaining print consumable amount is insufficient to completely render the print job. In another embodiment, the interrupting step 106 provides the user with an option of adjusting the print quality setting of the print job, which, as mentioned above, affects the amount of print consumable used to render the image. By appropriately adjusting the print quality setting of the print job, the requested print consumable amount can be reduced such that it does not exceed the remaining print consumable amount.

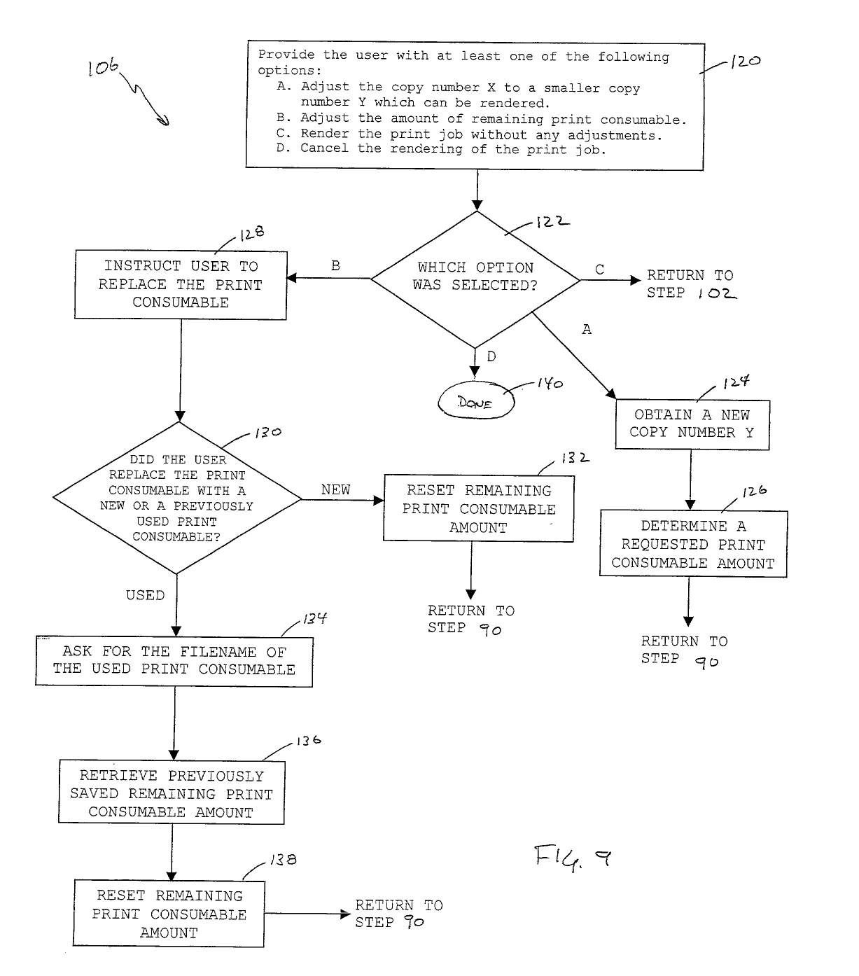

FIG. 9 shows yet another embodiment of the interrupting step 106, which begins at step 120 by providing the user with one or more options. The options include: A. adjusting the current copy number X to a smaller copy number Y; B. adjusting the amount of the remaining print consumable; C. rendering the print job without any adjustments; and D. canceling the rendering of the print job. Each of these listed options constitutes an individual embodiment of the invention. However, one embodiment of the invention includes providing the user with some or all of the options listed in step 120 including the option to reduce the print quality setting of the print job mentioned above. At step 122, the option selected by the user is determined.

If option A. is selected, the method moves to step 124 where the user is prompted to enter a new copy number for the print job. At step 126, a requested print consumable amount is determined based upon the new copy number and the requested print consumable amount used to print a single image as discussed above. Finally, the method returns to step 90 of the flowchart of FIG. 6 where the method continues as previously discussed.

If the user selects option B., the user is prompted to replace the print consumable currently loaded in CD printing device 24, as indicated at step 128. In one embodiment of step 128, the user is first prompted to provide a filename for the print consumable that is to be replaced. Once entered, a processor of CD printing system 20, such as microprocessor 28 or printer controller 34, stores the remaining print consumable amount of the print consumable in memory 30 or 38 (FIG. 2) under the filename provided by the user for later retrieval by the user. Alternatively, the remaining print consumable amount can be stored in memory circuit 64 of the print consumable 52, shown in FIG. 3. Next, the user is prompted to replace the print consumable currently loaded in CD printing device 32 with a different print consumable. This may involve, for example, replacing ink cartridge 52 (FIG. 3) of an inkjet printer, replacing a toner cartridge of a laser printer, replacing a thermal dye ribbon of a dye sublimation printer, or replacing a wax ribbon of a wax thermal transfer printer.

At step 130, it is determined whether the user replaced the print consumables with a new or a used print consumable. If the user replaced the print consumable with a new print consumable the remaining print consumable amount is updated to the new print consumable amount at step 132. The new print consumable amount is typically a quantity of print consumable that is known CD printing system 20 or one that can be provided by the user. After updating the remaining print consumable amount, the method continues at step 90 of FIG. 6. If the user replaces the print consumable with a used print consumable, the user is prompted, at step 134, to provide a filename that relates to the used print consumable. The filename identifies data in memory of CD printing system 20 relating to the amount of print consumable stored therein, which is retrieved at step 134 and used to update the remaining print consumable amount at step 136. Finally, the method continues at step 90 of the flowchart of FIG. 6.

If the user selects option C in step 120, the method moves to step 102 of FIG. 7 where the is rendered previously discussed. If the user selects option D at step 120, the print job is cancelled as indicated at step 140.

Although the present invention has been described with reference to preferred embodiments, workers skilled in the art will recognize that changes may be made in form and detail without departing from the spirit and scope of the invention. For example, the CD printing device 24 of CD printing system 20 (FIG. 2) could be modified to perform the functions of computer 22 thereby eliminating the need for computer 22.

What is claimed is:

1. A method for monitoring at least one print consumable of a compact disc (CD) printing system, comprising:
(a) estimating a number of images that can be printed before the print consumable reaches a low threshold or becomes depleted based upon a remaining print consumable amount defined as an amount of print consumable that is available to the CD printing system and a requested print consumable amount; and
(b) displaying print consumable information including the number of the images that can be printed.

2. The method of claim 1, wherein the requested print consumable amount relates to an amount of print consumable required to print a default image.

3. The method of claim 1, wherein the requested print consumable amount relates to an average or maximum print consumable amount based upon a print history.

4. The method of claim 1, wherein the requested print consumable amount relates to an amount of print consumable required to print a single image or all images of a print job.

5. The method of claim 1, wherein the print consumable information includes at least one of a number of black and white images that can be printed, a number of color images that can be printed, the remaining print consumable amount, a remaining black ink print consumable amount, a remaining color ink print consumable amount, an average number of prints rendered per print consumable, a maximum number of prints rendered per print consumable, and a minimum number of prints rendered per print consumable.

6. The method of claim 1, wherein the print consumable information includes a graphical or textual representation of the number of images that can be printed.

7. The method of claim 6, wherein the graphical representation is a bar graph.

8. The method of claim 1, including a step (c) of updating the remaining print consumable amount and repeating steps (a) and (b).

9. A method for monitoring at least one print consumable of a compact disc (CD) printing system, comprising:
(a) receiving a print job, wherein the print job includes an image file representing an image and a copy number representing the number of times the image is to be printed;
(b) determining a requested print consumable amount defined as an amount of print consumable needed to render the print job;
(c) estimating a number of images that can be printed before the print consumable reaches a low threshold or becomes depleted based upon a remaining print consumable amount defined as an amount of print consumable that is available to the CD printing system and the requested print consumable amount; and
(d) displaying print consumable information including the number of images that can be printed.

10. The method of claim 9, including a steps of:
(e) interrupting a rendering of the print job when the copy number exceeds the number of images that can be printed; and
(f) rendering the print job when the copy number is less than or equal to the number of images that can be printed.

11. The method of claim 10, wherein the interrupting step (e) includes providing a warning indicating that there may be insufficient print consumable available to complete the print job.

12. The method of claim 10, wherein the interrupting step (e) comprises providing the user with an option of adjusting the copy number of the print job.

13. The method of claim 10, wherein the interrupting step (e) includes providing at least one option selected from a group consisting of adjusting a print quality setting of the print job, adjusting the remaining print consumable amount, rendering the print job without any adjustments, and canceling the rendering of the print job.

14. The method of claim 10, wherein the determining step (b) further comprises determining a single print consumable amount defined as the amount of print consumable needed to print a single copy of the image file, wherein the requested print consumable amount is determined by multiplying the single print consumable amount by the copy number.

15. The method of claim 10, wherein the rendering step (f) comprises:
(f)(i) printing an image represented by the image file;
(f)(ii) updating the remaining print consumable amount;
(f)(iii) updating the displayed print consumable information; and
(f)(v) repeating steps (f)(i)-(f)(iii) until the print job is completely rendered.

16. The method of claim 9, wherein the print consumable information includes at least one of a number of black and white images that can be printed, a number of color images that can be printed, the remaining print consumable amount, a remaining black ink print consumable amount, a remaining color ink print consumable amount, an average number of prints rendered per print consumable, a maximum number of prints rendered per print consumable, and a minimum number of prints rendered per print consumable.

17. A compact disc (CD) printing system for processing a print job having an image file representing an image and a copy number representing a number of CD's on which the image is to be recorded, comprising:
a print consumable having a remaining print consumable amount;
a print mechanism for recording the image of the print job onto a CD using the print consumable;
a print consumable memory having print consumable information stored therein, the print consumable information including the a remaining print consumable amount;
a display device; and
at least one processor adapted to perform steps of:
(a) retrieving print consumable information from the print consumable memory;
(b) estimating a number of images that can be printed before the print consumable reaches a low threshold or becomes depleted based upon the remaining print consumable amount and a requested print consumable amount; and
(c) displaying print consumable information including the number of the images that can be printed.

18. The system of claim 17, wherein the requested print consumable amount relates to an amount of print consumable required to print a default image or an average print consumable amount calculated in accordance with a print history.

19. The system of claim 17, wherein the requested print consumable amount relates to an amount of print consumable required to print the image of the print job.

20. The system of claim 17, wherein the print consumable memory is a component of a personal computer, a CD printing device, or a print consumable cartridge housing the print consumable.
